(19) United States
(12) Patent Application Publication
(10) Pub. No.: US 2024/0206507 A1
(43) Pub. Date: Jun. 27, 2024

(54) LOW-CALORIE DESSERTS

(71) Applicant: DMK Deutsches Milchkontor GmbH, Zeven (DE)

(72) Inventors: Sven-Rainer DÖRING, Zeven (DE); Marco STEFFENS, Elsdorf (DE)

(21) Appl. No.: 18/533,454

(22) Filed: Dec. 8, 2023

(30) Foreign Application Priority Data
Dec. 15, 2022 (EP) 22 213 931.3

(51) Int. Cl. A23L 9/20; A23C 9/12; A23C 19/076; A23L 9/10

(52) U.S. Cl. CPC A23L 9/20; A23C 9/1206; A23C 19/0765; A23L 9/12

(57) ABSTRACT

What are proposed are low-calorie food products comprising or consisting of
(a) at least one milk component and
(b) specific galactooligosaccharides (GOS).

### FIELD OF THE INVENTION

The present patent application relates to desserts comprising milk components and specific oligomeric carbohydrates based on skimmed milk, and to the use of the carbohydrates as cream substitute.

### TECHNOLOGICAL BACKGROUND

### Galactooligosaccharides (GOS)

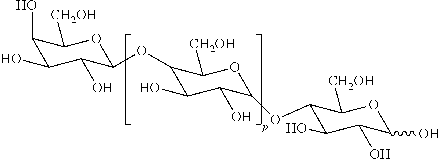 [0003] also known as oligogalactosyllactose, oligogalactose, oligolactose or transgalactooligosaccharides (TOS), form part of the group of prebiotics. GOS occurs in commercial products such as food for infants and adults.

Because of the configuration of their glycosidic bonds, galactooligosaccharides (GOS) largely withstand hydrolysis by saliva enzymes and digestion enzymes. Galactooligosaccharides are therefore classified as prebiotics, defined as indigestible food constituents that have a beneficial effect on the host, in that they stimulate the growth and/or activity of useful bacteria in the large intestine. This elevated activity of these health-promoting bacteria leads to a number of effects, both directly by virtue of the bacteria themselves and indirectly by virtue of the organic acids that they produce by fermentation. Examples of effects are stimulation of the immune functions, uptake of essential nutrients, and synthesis of particular vitamins.

Galactooligosaccharides are a substrate for bacteria such as bifidobacteria and lactobacilli. Studies with infants and adults have shown that foods or drinks enriched with galactooligosaccharides lead to a significant increase in bifidobacteria. These sugars occur naturally in human milk and are known as human milk oligosaccharides. Examples are lacto-N-tetraose, lacto-N-neotetraose and lacto-N-fucopentaose.

The human intestinal microbiota plays a major role in the intestinal immune system. Galactooligosaccharides support the natural defenses of the human body via the intestinal microflora indirectly in that they increase the number of bacteria in the intestine and inhibit the binding or survival of Escherichia coli, Salmonella Typhimurium and Clostridia. GOS can have an indirect positive influence on the immune system via the production of antimicrobial substances in that they reduce the replication of pathogenic bacteria. Constipation is a potential problem, particularly in infants, older people and pregnant women. In the case of infants, feeding with infant food can be associated with constipation and hard stool. GOS can improve stool frequency and alleviate the symptoms associated with constipation.

The typical obtaining of GOS comprises the following steps:
1. Concentration of a lactose solution, acid whey, milk permeate, with the aim of achieving a dry mass of at least 30% by weight);
2. High-temperature/UHT treatment for sterilization at 85-140° C. for 5 to 300 s;
3. Addition of the beta-galactosidase enzyme (e.g. Aspergillus Oryzae) and establishment of the optimal pH and temperature conditions for the enzyme (e.g. pH=4.5, 55° C.);
4. A dwell time of generally more than 30 to a maximum of 1200 min (depending on the enzyme), since there is otherwise redissociation;
5. Thermal inactivation of the enzyme, for example by high-temperature pasteurization (90° C., 10 min)
6. Purification, optionally concentration, spray drying.

There is also a review relating to the production of galactooligosaccharides by K. Zerge in an online publication by the University of Dresden:
https://nbn-resolving.org/urn:nbn:de:bsz:14-qucosa-157121

### RELEVANT PRIOR ART

EP 2620506 B1 (DUPONT) relates to the recovery of GOS proceeding from lactitol.

EP 3598901 B1 (HOCHSCHULE ANHALT) relates to a process for producing GOS, in which a beta-galactosidase derived from L. bulgaricus (L. delbrueckii spp. bulgaricus) is incubated at a temperature of 37° C. or less with a lactose-containing composition such as milk, buffer or whey, e.g. sweet whey, acid whey, whey concentrate or whey permeate.

EP 3041945 B1 (FRIESLAND) provides a process for producing GOS from lactose, which comprises (i) the contacting of a lactose charge with immobilized beta-galactosidase (EC 3.2.1.23) and (ii) the enabling of GOS synthesis, wherein the lactose charge is an aqueous slurry of crystalline lactose.

WO 2008 037839 A1 (VALIO) relates to a process for producing milk-based GOS-containing products by treatment with a beta-galactosidase.

WO 2018 048305 A1 (UNIV GRONINGEN) describes the use of a GOS composition comprising branched and linear GOS with a degree of polymerization (DP) of 3, wherein the branched DP3-GOS species are present in excess over the linear DP3-GOS species, for induction of mucin-glycan utilization pathways in useful intestinal bacteria in an animal.

WO 2018 210820 A1 (NOVOZYMES) claims a process in which milk substrate having a lactose content of at least 20% by weight of lactose is treated with an enzyme having transgalactosylating activity. The transgalactosylating activity of the enzyme may have been increased by glycation of lysine and/or arginine residues by incubation of the enzyme with high glucose concentrations at elevated temperatures.

WO 2020 049016 A1 (FRIESLAND) relates to the field of hypoallergenic oligosaccharides for use in food compositions, especially to oligosaccharides having prebiotic properties. A hypoallergenic oligosaccharide composition is provided, comprising galactooligosaccharides (GOS), wherein (i) the content of galactooligosaccharides (GOS) is at least 40% by weight of the total dry matter of the composition; (ii) the content of allolactose is at least 10% by weight of the total dry matter of the composition; (iii) the content of 6′-GL is at least 30% by weight of the total GOS in the composition; and (iv) at least 0.5% by weight of the total GOS has a degree of polymerization (DP) of six or more.

WO 2020 117548 A1 (DUPONT) relates to a process for providing a milk-based low-lactose product comprising GOS fibres, in which a milk substrate comprising lactose is treated with a transgalactosylating enzyme in order to provide GOS fibres and remaining lactose; deactivating the transgalactosylating enzyme; contacting the milk-based substrate comprising GOS fibres with a lactase in order to degrade the remaining lactose, in order to provide the milk-based low-lactose product comprising GOS fibres, and deactivating the lactase.

WO 2020 141032 A1 (FRIESLAND) relates to the field of food constituents, especially to economically attractive processes for producing hypoallergenic galactooligosaccharides (HA-GOS) and to the use thereof in foods and animal feeds. A process is provided for production of an HA-GOS preparation, which comprises the contacting of a lactose starting material with a specific beta-glycosidase (EC 3.2.1.23), wherein the lactose starting material is a cheese whey permeate (CWP) or a CWP enriched with sialyllactose (SL-CWP).

### OBJECT OF THE INVENTION

There is a need for food products, specifically for desserts, which do have the texture, creaminess and pleasant mouthfeel of a product produced with cream, but are free or essentially free (less than 2% by weight) of fats, especially of cream, and are correspondingly low or at least reduced in calories.

### DESCRIPTION OF THE INVENTION

The invention therefore firstly provides low-calorie food products, especially desserts, comprising or consisting of
(a) at least one milk component and
(b) galactooligosaccharides (GOS),
with the proviso that component (b) has been obtained by the following route:
(i) providing an aqueous solution comprising, consisting of or essentially consisting of proteins and lactose;
(ii) concentrating the aqueous solution from step (a);
(iii) sterilizing the aqueous solution from step (b) by pasteurization and/or micro/ultrafiltration;
(iv) transgalactosylating the lactose present in the sterilized aqueous solution from step (c) with addition of at least one beta-galactosidase within the optimal temperature and pH interval thereof over a period of at least 30 minutes to obtain a reaction mixture,
(v) deactivating the mass of enzyme in the reaction mixture from step (d) by thermal treatment over a period of about 5 to about 20 minutes, preferably at about 85 to about 95° C., and optionally
(vi) finishing the product thus obtained.

It has been found that, surprisingly, when the added enzyme is deactivated during the production of GOS formulations from skimmed milk or skimmed milk concentrates, a significant rise in viscosity is observed, and the viscosity can be controlled via the deactivation time. In this way, products that are low in fat and nevertheless have a texture typical of fat-containing products are obtained.

When the existing starting materials for GOS formulations that do not contain any proteins are used, thermal deactivation of the added enzymes does not lead to a significant increase in viscosity. Even when the enzymes are deactivated by a change in pH, the effect is not observed. Consequently, this is an entirely new product which is low in calories and free of fat, but contains large amounts of proteins and galactooligosaccharides.

The core of the invention accordingly consists in the surprising finding that galactooligosaccharides that are produced by a particular process and have the texture of a gel are suitable for use as a low-calorie substitute for cream in customary desserts without having to accept losses in product performance, especially with regard to taste and creaminess.

### Milk Products

In a first preferred embodiment of the invention, component (a) may be selected from the group formed by skimmed milk, whole milk, yoghurt, buttermilk, sweet whey, acid whey, kefir and quark.

### Galactooligosaccharides

Useful feedstocks for the production of galactooligosaccharide formulations include protein-rich lactose solutions based on skimmed milk or skimmed milk concentrates as aqueous protein and lactose solutions, these typically having a protein content of about 10% to about 20% by weight and a lactose content of about 15% to about 30% by weight. What is important, and common to the suitable feedstocks, is that they have a sufficient amount of lactose, specifically glycosidically bound lactose, and additionally have a high proportion of proteins.

Lactose is a sugar present in milk.

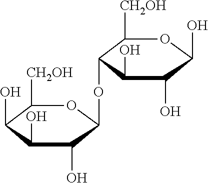

The disaccharide consists of the two molecules D-galactose and D-glucose that are bonded to one another via a β-1,4-glycosidic bond. The IUPAC name for lactose is 4-O-(β-D-galactopyranosyl)-D-glucopyranose. It occurs as the main energy carrier in the milk of mammals. Lactose is digested in the small intestine by the enzyme lactase, i.e. split into glucose and galactose. In the milk of mammals and in milk products, lactose accounts for almost the entire proportion of the carbohydrates. Lactose provides energy, assists the absorption of calcium, inhibits putrefactive bacteria in the human intestine, and promotes bifidus bacteria (bifidobacterium).

Whey is the aqueous greenish-yellow residual liquid formed in cheese production. It is the liquid portion that can be separated out after the milk has coagulated to form cheese or quark. Acid whey forms in the production of soured milk products.

It is advisable to use lactose solutions with a sufficiently high amount of solids (synonym: dry matter) in order to be able to perform the process according to the invention with economically viable yields and conversions. Suitable solutions for this purpose are those that have an amount of solids of about 25% to about 50% by weight and preferably about 30% to about 35% by weight. It may be necessary to correspondingly concentrate industrial lactose solutions, for example by reverse osmosis (RO).

### Sterilization

In the first step of the process according to the invention, the aqueous lactose solutions are sterilized. This is understood to mean any process by which the microbial load of the natural starting material can be reduced to a value below that fixed by the respective national testing authorities as threshold for approval as foods. In general, the lactose solutions are sterilized to below 1000 microbes/ml, preferably to below 500 microbes/ml and especially about 10 to about 50 microbes/ml. The preferred sterilization method is a high-temperature treatment in which the solutions are subjected to a temperature in the range from about 70 to about 150° C., preferably about 90 to about 120° C., for about 3 to about 300 seconds, preferably about 50 to about 200 seconds. Alternatively, it is possible to conduct a microfiltration. There is no need for a sterilization if a sterilized lactose solution is already being used.

Useful feedstocks for the production of galactooligosaccharide formulations include protein-rich lactose solutions based on skimmed milk or skimmed milk concentrates as aqueous protein and lactose solutions, these typically having a protein content of about 10% to about 20% by weight and a lactose content of about 15% to about 30% by weight. What is important, and common to the suitable feedstocks, is that they have a sufficient amount of lactose, specifically glycosidically bound lactose, and additionally have a high proportion of proteins.

### Thermal Deactivation of Enzymes

The transgalactosylation is preferably conducted until the maximum GOS concentration has been attained. This value, which depends on the enzyme and reaction conditions, can be monitored by sampling and hence ascertained easily by the person skilled in the art. Once the maximum GOS formation has been attained, the activity of the enzymes has to be stopped very quickly in order to prevent redissociation. This is effected by rapid high-temperature treatment, in which the enzyme material is fully denatured. The viscosity or solidity of the product is established via the duration of deactivation. Short periods of 1 to 5 minutes promote high solidities, whereas longer periods of up to 15 minutes lead to products of gel-like texture. The removal of the deactivated enzymes is optional and is preferably effected by filtration, which is preferably conducted continuously.

### Finishing

The product obtained after thermal deactivation and optionally removal of the mass of deactivated enzyme has a gel-like consistency and can be dispensed directly in that form. The actual finishing can be conducted under cold conditions at about 5 to about 21° C. or preferably under warm conditions at about 25 to about 35° C. Subsequently, the GOS are mixed with the milk components and any other additives, and the end product is dispensed into the corresponding packs.

### Auxiliaries and Additives

The desserts according to the invention may further comprise auxiliaries and additives selected from the group formed by plant proteins, plant fats, starch products, dietary fibres, thickeners, flavourings, prebiotics, probiotics, food acids, rennet, salts and dyes, and mixtures thereof.

In a preferred embodiment, the desserts may have the following composition, based in each case on the total weight:
(a) about 50% to about 80% by weight, preferably about 60% to 70% by weight, of milk components,
(b) about 25% to about 40% by weight, preferably about 30% to 35% by weight, of galactooligosaccharides;
(c1) 0% to about 10% by weight, preferably about 2% to about 5% by weight, of plant proteins;
(c2) 0% to about 10% by weight, preferably about 2% to about 5% by weight, of plant fats;
(c3) 0% to about 5% by weight, preferably about 1% to about 3% by weight, of starch products;
(c4) 0% to about 5% by weight, preferably about 1% to about 2% by weight, of dietary fibres;
(c5) 0% to about 5% by weight, preferably about 1% to about 2% by weight, emulsifiers;
(c6) 0% to about 2% by weight, preferably about 0.5% to about 1% by weight, of thickeners;
(c7) 0% to about 2% by weight, preferably about 0.5% to about 1% by weight, of flavourings;
(c8) 0% to about 1% by weight, preferably about 0.1% to about 0.5% by weight, of probiotic microorganisms;
(c9) 0% to about 1% by weight, preferably about 0.1% to about 0.5% by weight, of prebiotic substances;
(c10) 0% to about 1% by weight, preferably about 0.1% to about 0.5% by weight, of food acids, (c11) 0% to about 1% by weight, preferably about 0.1% to about 0.5% by weight, of sweeteners;
(c12) 0% to about 1% by weight, preferably about 0.1% to 0.5% by weight, of antioxidants and/or vitamins;
(c13) 0% to about 1% by weight of rennet;
(c14) 0% to about 1% by weight of salts;
(c15) 0% to about 0.5% by weight of dyes;
   with the proviso that the stated amounts, with or without water, add up to 100% by weight. The further auxiliaries and additives are elucidated by way of example hereinafter. For the sake of good order, it should be pointed out that formulations that do not add up to 100% by weight in this way are not part of the invention, and it is possible for the person skilled in the art at any time, on the basis of the present description, to select formulations wherein the components add up to 100% by weight and satisfy the technical teaching.

### Plant Proteins

Plant proteins in the context of the invention (component c1) may be obtained from potatoes, soya, peas, lupins, oilseed rape or other protein-rich fruits, for example sunflower or pumpkin seeds and the like. The harvested protein-containing fruits are mechanically comminuted and defatted. The result is flakes or a protein-rich powder. Subsequently, a protein concentrate is obtained using solvents, which is optionally purified and concentrated further to give protein isolate. The flakes or meal are admixed with water and converted to a slurry. The low-protein fibres and solids are separated from the protein-rich solution in the next step with the aid of industrial centrifuges. This is followed by what is called the precipitation. The pH of the protein-rich solution is adjusted here to the isoelectric point. This results in sedimentation of the protein particles. These are then separated in turn from the liquor by means of centrifuges. In order to remove all constituents of the mother liquor from the precipitated and removed protein, the protein is admixed again with water and separated off again with the aid of centrifugal force. In the case of dry extrusion, with supply of heat, pressure and auxiliaries, an intermediate with a low water content is produced. These likewise suitable proteins are referred to as TVP (texturized vegetable protein) and have a dry consistency in the form of grains, strips or flakes. In the case of wet extrusion, alternatively, operation is effected with a higher water content. The moisture content of the intermediate is therefore closer to the water content of the end product. The intermediate is referred to as HMMA (high moisturized meat analogues).

### Plant Fats

Plant fats (component c2) are lipids that contain essentially saturated fatty acids and are therefore in solid form at ambient temperature. The solid plant fats include, in particular, coconut oil, palm oil, palm kernel oil and shea butter.

### Starch Products

In the context of the present invention, the term “starch products” (component c3) includes natural starches, and likewise chemically or enzymatically modified starches, provided that they are approved for human nutrition, and dextrins.

Potato starch Potatoes contain about 75% water, 21% starch and 4% other substances. The traditional way of producing potato starch is to very finely comminute them on fast-rotating sawtoothed cylinders with supply of water. Thereafter, the pulp, in which the cells should be very substantially torn open, i.e. the starch grains exposed, is extracted by washing with water on a metal screen on which brushes rotate slowly. In larger facilities, continuous apparatuses are used, in which the pulp is gradually transported over a long, inclined screen by a chain, in the course of which it is extracted by washing, and the water flowing over the already almost exhausted pulp, which thus takes up only very little ground starch, is also guided onto fresh pulp. The pulp that has been extracted by washing contains 80-95% water, but the dry matter still contains about 60% starch and serves as animal feed, and also for starch sugar production, spirits production and papermaking; the wash water was used for watering of meadows, but it was also possible to utilize the nitrogen-containing constituents of the potato water as animal feed. Since the pulp still contains a very large amount of starch, it is comminuted between rollers in order to open all cells, and then extracted by washing once again. In another method, the potatoes are cut into slices, they are freed of their juice by maceration in water, and they are layered with brushwood or wattles to form heaps in which they rot completely at a temperature of 30-40° ° C. within about eight days and are transformed to a looser, slurry-like mass, from which the starch can be easily extracted by washing. The water that flows off the screens contains the juice constituents of the potatoes in dissolved form, and starch and fine fibres that have passed through the screen in suspended form. This water is stirred in vats and left to stand for a short time in order that sand and small stones can fall to the base, it is then allowed to flow through a fine sieve in order to retain coarser fibres, and then it is introduced into a vat in which the starch, and on it the fibres, are deposited. The upper layer of the sediment is therefore removed after the water has been drained and utilized directly as starch slurry, or purified further by extracting it by washing with a large amount of water on an agitated screen made of fine silk gauze, through the meshes of which the starch passes, but the fibres do not. The main mass of the starch is repeatedly stirred up in the vat with pure water, and freed of the upper impure starch after each settling operation. It is also possible to allow the crude starch to flow through a very slightly inclined channel with water, in the upper part of which the heavy pure starch is deposited, while the lighter fibres are carried further downward by the water.

Centrifugal machines are often also used, in which the heavy starch is first deposited on the vertical wall of the fast-rotating screen drum, while the light fibre still remains suspended in the water. But the water escapes through the screen wall, and the starch can ultimately be lifted out of the centrifugal machine in solid blocks, the inner layer of which is formed by the fibre. The moist (green) starch containing about 33-45% water is processed directly to glucose, but for all other purposes is dewatered on filter presses or on sheets of baked gypsum which absorb plenty of water, also with use of an air pump, and dried at a temperature below 60° ° C. It is traded after being converted to lumps, or as meal having been crushed between rolls and sieved. The moist starch is sometimes kneaded with a little paste and driven through a perforated iron plate, and then the strands obtained are dried on hurdles. In order to conceal a yellowish hue of starch, a little ultramarine is added thereto before the last wash.

Wheat starch Wheat starch is produced from white, thin-husked, farinaceous wheat. This contains about 58-64% starch, and also about 10% gluten and 3-4% cellulose that forms mainly the husks of the grain. The properties of the gluten cause the variances in wheat starch fabrication from the obtaining of starch from potatoes. In the traditional Halle or acid method, the wheat is softened in water, squashed between rolls and left to ferment under water; fermentation is initiated by acid water from an earlier process and affords acetic acid and lactic acid in which the gluten is dissolved or at least loses its viscosity such that it is possible to separate out the starch after 10-20 days in a wash drum with a sieve-like pattern of holes. The water that flows out of the drum, in a vat, firstly exudes starch, then an intimate mixture of starch with gluten and husk particles (slip, starch sludge), and lastly a sludgy mass consisting predominantly of gluten. This raw starch is purified and then dried similarly to potato starch, breaking down into powder, or, if it still contains small amounts of gluten, giving what is called crystal starch, which is incorrectly assumed by normal consumers to be particularly pure.

In the traditional Alsace method, the swollen wheat is squeezed by upright millstones with a strong inflow of water and extracted by washing immediately. The effluxing water, as well as starch, contains a large amount of gluten and husked particles, and is either left to ferment and then processed further as in the preceding process, or transferred directly to centrifugal machines where a large amount of gluten is separated out and a crude starch is obtained, which is purified further by fermentation etc. The residues obtained in this process have considerably higher agricultural value than those formed in the Halle process. But if the intention is to utilize the gluten even more advantageously, a firm, tough dough is made from wheat flour and, after about one hour, processed into 1 kg pieces in a channel-shaped trough with supply of water using a slightly fluted roll. In the course of this, the starch is washed out of the gluten and flows away with the water, while the gluten is retained as a viscous, threading material.

Rice starch Rice contains about 70-75% starch, as well as 7-9% insoluble protein-like substances, but these are dissolved for the most part by softening the rice in quite weak sodium hydroxide solution. The rice is then comminuted in a mill with constant inflow of weak alkali, the slurry is subjected to sustained treatment with alkali and water in a vat, and is left to settle for a short time, in order that coarser particles fall to the base, and the water in which pure starch is suspended is drawn off. The starch is washed out of the sediment by water in a rotating screen cylinder, and then it is freed of the gluten by treatment with alkali and slurrying. The purer starch obtained first can then be left to settle out, the upper, impure layer is removed, the rest is treated in the centrifugal machine, and the pure starch is dried.

Maize starch Maize is softened four to five times for 24 hours each time in water at 35° C., washed and then passed through two milling operations. The flour falls into a water-filled vat with paddle stirrers, and passes therefrom onto silk fabric that retains only the coarse bran. The starch-laden water that has passed through the fabric goes into troughs, then passes through two fine fabrics and finally onto a slightly inclined slate tablet of 80-100 m in length, on which the starch is deposited. The water flowing away, which contains only traces of starch, is left to stand, the sediment is pressed to cakes, in order to use it as animal feed. Particular preference is given to the use of rice starch or maize starch.

Dextrins Dextrins or maltodextrins are starch degradation products which, in terms of their molecular size, are between oligosaccharides and starch. They typically occur in the form of white or pale yellow powder. They are obtained mainly from wheat starch, potato starch, tapioca starch and maize starch by dry heating (>150° C.) or under the action of acid. In nature, dextrin is produced, for example, by Bacterium macerans. Dextrins are also formed by the enzymatic degradation of starch by amylase. Preference is given to dextrins with 5 to 20 and especially 6 to 10 dextrose equivalents (DE units).

### Dietary Fibres

Dietary fibres (component c4) are largely indigestible food constituents, usually carbohydrates, that are usually present in plant-based foods and are an important part of human nutrition. In yet a further preferred embodiment of the present invention, the dietary fibre is selected from the group consisting of inulin, carob seed flour, pectin, dextrin, maltodextrin, cellulose, lignin and alginate, or mixtures thereof.

### Emulsifiers

Emulsifiers (component c5) are notable for the important property of being soluble both in water and in fat. Emulsifiers usually consist of a fat-soluble and a water-soluble component. They are used whenever water and oil are to be converted to a stable, homogeneous mixture. Suitable emulsifiers that are used in the food-processing industry are selected from: ascorbyl palmitate (E 304) lecithin (E 322) phosphoric acid (E 338) sodium phosphate (E 339) potassium phosphate (E 340) calcium phosphate (E 341) magnesium orthophosphate (E 343) propylene glycol alginate (E 405) polyoxyethylene(8) stearate (E 430) polyoxyethylene stearate (E 431) ammonium phosphatides (E 442) sodium phosphate and potassium phosphate (E 450) sodium salts of the food fatty acids (E 470 a) mono- and diglycerides of food fatty acids (E 471) acetic acid monoglycerides (E 472 a) lactic acid monoglycerides (E 472 b) citric acid monoglycerides (E 472 c) tartaric acid monoglycerides (E 472 d) diacetyltartaric acid monoglycerides (E 472 e) sugar esters of food fatty acids (E 473) sugar glycerides (E 474) polyglycerides of food fatty acids (E 475) polyglycerol polyricinoleate (E 476) propylene glycol esters of food fatty acids (E 477) sodium stearoyllactylate (E 481) calcium stearoyl-2-lactylate (E 482) stearyl tartrate (E 483) sorbitan monostearate (E 491) stearic acid (E 570).

### Thickeners

Thickeners (component c6) are substances capable primarily of binding water. Removal of unbound water results in an increase in viscosity. Over and above a concentration characteristic of each thickener, network effects also occur as well as this effect, which lead to a usually greater-than-proportional increase in viscosity. In this case, it is said that molecules ‘communicate’ with one another, i.e. become interlooped. Most thickeners are linear or branched macromolecules (e.g. polysaccharides or proteins) that can interact with one another via intermolecular interactions, such as hydrogen bonds, hydrophobic interactions or ionic relationships. Extreme cases of thickeners are sheets silicates (bentonites, hectorites) or hydrated SiO₂ particles that are dispersed as particles and can bind water in their solid-state structure or can interact with one another on account of the interactions described.

Useful thickeners are conventionally gelatins in particular. Since animal-based products are now undesirable in many cases, it is possible to use as an alternative plant-based products, for example

E 400 - alginic acid
E 401 - sodium alginate
E 402 - potassium alginate
E 403 - ammonium alginate
E 404 - calcium alginate
E 405 - propylene glycol alginate
E 406 - agar agar
E 407 - carrageenan, furcelleran
E 407 - carob seed flour
E 412 - guar seed flour
E 413 - tragacanth
E 414 - gum arabic
E 415 - xanthan gum
E 416 - karaya (Indian tragacanth)
E 417 - tara bean flour (Peruvian carob seed flour)
E 418 - gellan gum
E 440 - pectin, Opekta
E 440ii - amidated pectin
E 460 - microcrystalline cellulose powder, cellulose powder
E 461 - methylcellulose
E 462 - ethylcellulose
E 463 - hydroxypropylcellulose
E 465 - methylethylcellulose
carboxymethylcellulose, sodium carboxymethylcellulose

### Flavourings

The food products according to the invention may comprise one or more flavourings (component c7). Typical examples include: acetophenone, allyl caproate, alpha-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidenephthalide, carvone, camphene, caryophyllene, cineole, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethyl isobutyrate, ethyl isovalerate, ethyl lactate, ethyl methylbutyrate, ethyl propionate, eucalyptol, eugenol, ethyl heptylate, 4-(p-hydroxyphenyl)-2-butanone, gamma-decalactone, geraniol, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methyl methylbutyrate, 2-methyl-2-pentenolic acid, methyl thiobutyrate, 3,1-methylthiohexanol, 3-methylthiohexyl acetate, nerol, neryl acetate, trans, trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinols, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)-furanone and derivatives thereof (here preferably homofuraneol) (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethyl maltol), coumarin and coumarin derivatives, gamma-lactones (here preferably gamma-undecalactone, gammanonalactone, gamma-decalactone), delta-lactones (here preferably 4-methyl deltadecalactone, massoia lactone, deltadecalactone, tuberolactone), methyl sorbate, divanillin, 4-hydroxy-2(or 5)-ethyl-5(or 2)-methyl-3(2H)-furanone, 2-hydroxy-3-methyl-2-cyclopentenone, 3-hydroxy-4,5-dimethyl-2(5H)-furanone, acetic acid isoamyl ester, butyric acid ethyl ester, butyric acid n-butyl ester, butyric acid isoamyl ester, 3-methylbutyric acid ethyl ester, n-hexanoic acid ethyl ester, n-hexanoic acid allyl ester, n-hexanoic acid-n-butyl ester, n-octanoic acid ethyl ester, ethyl 3-methyl-3-phenylglycidate, ethyl 2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl) disulfide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol, and stereoisomers, enantiomers, positional isomers, diastereomers, cis/trans isomers or epimers of these substances (which are not explicitly specified here).

The flavourings may also be added in solid or pasty form, for example as dried seasoning mixtures or chopped herbs.

### Probiotic Microorganisms

Probiotic microorganisms, which are also referred to as “probiotics” (component c8), are living microorganisms that have properties useful to the host. According to the FAO/WHO definition, they are “live microorganisms which when administered in adequate amounts confer a health benefit on the host”. Lactic acid bacteria (LAB) and bifidobacteria are the best-known probiotics, but it is also possible to use various yeasts and bacilli. Probiotics are typically consumed as a constituent of fermented foods, to which special living cultures have been added, for example yoghurt, soya yoghurt or other probiotic foods. In addition, tablets, capsules, powders and sachets that contain these microorganisms in freeze-dried form are also obtainable. Table A gives an overview of commercial probiotics and the corresponding health claims that can be used as component (b1) in the context of present invention.

TABLE A
Probiotic substances

| Strain | Name | Manufacturer | Claim |
|---|---|---|---|
| Bacillus coagulans | GanedenBC | Ganeden Biotech | Increases the immune response |
| GBI-30, 6086 | | | on viral infection |
| Bifidobacterium animalis | Probio-Tec | Chr. Hansen | Human clinical studies have |
| subsp. lactis BB-12 | Bifidobacterium | | shown that BB-12 alone or in |
| | BB-12 | | combination has a positive ef- |
| | | | fect on the gastrointestinal sys- |
| | | | tem |
| Bifidobacterium infantis | Align | Procter & Gamble | In a preliminary study, it was |
| 35624 | | | shown that the bacterium |
| | | | can reduce abdominal pain. |
| Lactobacillus acidophilus | | Danisco | A study shows that the side |
| NCFM | | | effects of antibiotic treat- |
| | | | ments are reduced. |
| Lactobacillus paracasei | | | |
| St11 (or NCC2461) | | | |
| Lactobacillus johnsonii | | Nestlé | Reduces gastritis complaints |
| La1 (= Lactobacillus | | | and reduces inflammation. |
| LC1, Lactobacillus johnsonii | | | |
| NCC533) | | | |
| Lactobacillus plantarum | GoodBelly/Pro- | Probi | May improve IBS symptoms; |
| 299v | Viva/ProbiMage | | but more studies required. |
| Lactobacillus reuteri | | BioGaia | First signs of efficacy against |
| American Type Culture | | | gingivitis, fever in children |
| Collection\|ATTC 55730 | | | and reduction in days of ill- |
| (Lactobacillus reuteri | | | ness in adults. |
| SD2112) | | | |
| Lactobacillus reuteri | | | |
| Protectis (DSM 17938, | | | |
| daughter strain of | | | |
| ATCC 55730) | | | |
| Saccharomyces boulardii | DiarSafe and | Wren Laborato- | Limited evidence in the treat- |
| | others | ries | ment of acute diarrhoea. |
| Lactobacillus rhamnosus | Bion Flore In- | Chr. Hansen | Evidence of efficacy against |
| GR-1 & | time/Jarrow | | vaginitis in one study. |
| Lactobacillus reuteri | Fem-Dophilus | | |
| RC-14 | | | |
| Lactobacillus acidophilus | Florajen3 | American Lifeline, | First signs of efficacy against |
| NCFM & | | Inc | CDAD |
| Bifidobacterium bifidum | | | |
| BB-12 | | | |
| Lactobacillus acidophilus | Bio-K+ CL1285 | Bio-K+ | Pointers of improvement in |
| CL1285 & | | International | digestion, especially with re- |
| Lactobacillus casei | | | gard to lactose intolerance. |
| LBC80R | | | |
| Lactobacillus plantarum | Bravo Friscus/ | Probi | Studies currently underway |
| HEAL 9 & | ProbiFrisk | | with regard to efficacy |
| Lactobacillus paracasei | | | against colds. |
| 8700:2 | | | |

Two further forms of lactic acid bacteria, namely Lactobacillus bulgaricus and Streptococcus thermophilus, are likewise suitable as probiotics. Specific fermented products based on such lactic acid bacteria are also usable; for example mixed pickles, fermented soybean paste, for example tempeh, miso and doenjang; kefir; buttermilk, kimchi; pao cai; soy sauce or zha cai.

### Prebiotic Substances

In a further configuration of the invention, the formulations may further comprise prebiotic substances (“prebiotics”) (component c9). Prebiotics are defined as indigestible food constituents, the administration of which stimulates growth or activity of a number of useful bacteria in the large intestine. The addition of prebiotic compounds improves the stability of the anthocyanins against degradation processes in the gastrointestinal tract. Various substances, especially carbohydrates that are particularly preferred as prebiotics in the context of the invention, are specified hereinafter, namely in particular
fructooligosaccharides
inulins
isomaltooligosaccharides
lactilol
lactulose
pyrodextrins
soya oligosaccharides
xylooligosaccharides
transgalactooligosaccharides and
specific biopolymers

Fructooligosaccharides, or FOS for short, especially include short-chain representatives having 3 to 5 carbon atoms, for example D-fructose and D-glucose. FOS, also called neosugars, are produced commercially on the basis of sucrose and the fructosyltransferase enzyme which is obtained from fungi. FOS especially promote the growth of bifidobacteria in the intestine and are marketed in the USA particularly together with probiotic bacteria in various functionalized foods.

Inulins belong to a group of naturally occurring fructose-containing oligosaccharides. They belong to a class of carbohydrates that are referred to as fructans. They are obtained from the roots of the chicory plant (Cichorium intybus) or what are called Jerusalem artichokes. Inulins consist predominantly of fructose units and typically have a glucose unit as end group. The fructose units are linked to one another via a beta-(2-1)-glycosidic bond. The average degree of polymerization of inulins that are employed as prebiotics in the foods sector is 10 to 12. Inulins likewise stimulate the growth of bifidobacteria in the large intestine.

Isomaltooligosaccharides are a mixture of alpha-D-linked glucose oligomers, including isomaltose, panose, isomaltotetraose, isomaltopentaose, nigerose, kojibiose, isopanose and higher branched oligosaccharides. Isomaltooligosaccharides are produced via various enzymatic routes. They likewise stimulate the growth of bifidobacteria and lactobacilli in the large intestine. Isomaltooligosaccharides are used especially in Japan as food additives in functionalized foods. They are now also widespread in the USA.

Lactilol is the disaccharide of lactulose. It is used in medicine to counter constipation and in the case of hepatic encephalopathy. In Japan, lactilol is used as a prebiotic. It withstands degradation in the upper digestive tract, but is fermented by various intestinal bacteria, which leads to a rise in the biomass of bifidobacteria and lactobacilli in the intestine. Lactilol is also known by the chemical name 4-O-(beta-D-galactopyranosyl)-D-glucitol. The medical field of use of lactitol in the USA is limited for lack of studies; in Europe it is preferably used as a sweetener.

Lactosucrose is a trisaccharide which is formed from D-galactose, D-glucose and D-fructose. Lactosucrose is produced by enzymatic transfer of the galactosyl residue in lactose to sucrose. It is not degraded in the stomach or in the upper part of the gastrointestinal tract, and is consumed exclusively by bifidobacteria for growth. From a physiological standpoint, lactosucrose acts as a simulator for the growth of intestinal flora. Lactosucrose is likewise known as 4G-beta-D-galactosucrose. It is widely used in Japan as a food additive and as a constituent of functionalized foods, especially also as an additive for yoghurts. Lactosucrose is currently also being tested in the USA for a similar end use.

Lactulose is a semisynthetic disaccharide formed from D-lactose and D-fructose. The sugars are linked by a beta-glycosidic bond, which makes them resistant to hydrolysis by digestive enzymes. Instead, lactulose is fermented by a limited number of intestinal bacteria, which leads to growth of lactobacilli and bifidobacteria in particular. Lactulose in the USA is a prescribed medicament to counter constipation and hepatic encephalopathy. In Japan, by contrast, it is freely sold as a food additive and constituent of functionalized foods.

Pyrodextrins comprise a mixture of glucose-containing oligosaccharides that are formed on hydrolysis of starch. Pyrodextrins promote the proliferation of bifidobacteria in the large intestine. They are also not degraded in the upper region of the intestine.

Soya oligosaccharides are specific saccharides that are found essentially only in soybeans and additionally in other beans and peas. The two crucial representatives are the trisaccharide raffinose and the tetrasaccharide stachyose. Raffinose is composed of one molecule each of D-galactose, D-glucose and D-fructose. Stachyose consists of two molecules of D-galactose and one molecule each of D-glucose and D-fructose. Soya oligosaccharides stimulate the growth of bifidobacteria in the large intestine and are already being used in Japan as food additives and in functionalized foods. In the USA, they are currently being tested for this use.

Xylooligosaccharides contain beta-1,4-linked xylose units. The degree of polymerization of the xylooligosaccharides is between 2 and 4. They are obtained by enzymatic hydrolysis of the polysaccharide xylan. They are already being marketed as food additives in Japan; they are still in the test phase in the USA.

Transgalactooligosaccharides (TOS) are mixtures of oligosaccharides based on D-glucose and D-galactose. TOS are produced proceeding from D-lactose with the aid of the enzyme betaglucosidase from Aspergillus oryzae. Like many other prebiotics, TOS are also stable in the small intestine and stimulate the growth of bifidobacteria in the large intestine. TOS are already being marketed as food additives both in Europe and in Japan.

Suitable biopolymers that are likewise useful as prebiotic, for example beta-glucans, are notable in that they are produced on a plant basis; for example, useful raw material sources include cereals such as oats and barley, but also fungi, yeasts and bacteria. Microbially produced cell wall suspensions or whole cells with a high beta-glucan content are also suitable. Residual contents of monomers have 1-3 and 1-4 or 1-3 and 1-6 linkages, and the content may vary significantly. What are preferably obtained are beta-glucans based on yeasts, especially Saccharomyces, specifically Saccharomyces cerevisiae. Other suitable biopolymers are chitin and chitin derivatives, especially oligoglucosamine and chitosan, which is a typical hydrocolloid.

### Food Acids

The term “food acids” (component c10) refers to organic acids, fruit acids or phosphoric acids, which, because of their taste and other properties advantageous for food purposes, are used as additives, especially as food acids or acid regulators in food production, for example:

E 260 - acetic acid
E 270 - lactic acid
E 290 - carbon dioxide
E 296 - malic acid
E 297 - fumaric acid
E 330 - citric acid
E 331 - sodium citrate
E 332 - potassium citrate
E 333 - calcium citrate
E 334 - tartaric acid
E 335 - sodium tartrate
E 336 - potassium tartrate
E 337 - sodium potassium tartrate
E 338 - phosphoric acid
E 353 - metatartaric acid
E 354 - calcium tartrate
E 355 - adipic acid
E 363 - succinic acid
E 380 - triammonium citrate
E 513 - sulfuric acid
E 574 - gluconic acid
E 575 - glucono-delta-lactone

Preferably, in the context of the present invention, the food acids are selected from the group consisting of lactic acid, tartaric acid, acetic acid, malic acid, citric acid and fumaric acid. Even though a food product according to the invention may contain food acids that may (also) be used because of their taste in the context of the present invention, the food acids in the context of the present text are not assigned the term “flavouring” within the context of the wording of the claim (see above for flavourings to be used with preference). Such (further) flavourings are thus always additionally present.

### Sweeteners

The desserts may additionally comprise sweeteners (component c11). Since these are low-calorie or at least reduced-calorie foods, it is possible to use conventional sugars for sweetening, albeit less preferred. Instead, preference is given to using plant-based alternatives.

Useful sweeteners or sweet-tasting additives include firstly carbohydrates and specifically sugars, for instance sucrose, trehalose, lactose, maltose, melicitose, raffinose, palatinose, lactulose, D-fructose, D-glucose, D-galactose, L-rhamnose, D-sorbose, D-mannose, D-tagatose, D-arabinose, L-arabinose, D-ribose, D-glyceraldehyde, or maltodextrin. Likewise suitable are plant-based formulations that contain these substances, for example based on sugarbeet (Beta vulgaris ssp., sugar fractions, sugar syrup, molasses), sugarcane (Saccharum officinarum ssp., molasses, sugarcane syrup), maple syrup (Acer ssp.) or agaves (agave syrup).

Also useful are
synthetic, i.e. generally enzymatically produced, starch or sugar hydrolysates (invert sugar, fructose syrup),
fruit concentrates (for example based on apples or pears);
sugar alcohols (e.g. erythritol, threitol, arabitol, ribotol, xylitol, sorbitol, mannitol, dulcitol, lactitol);
proteins (e.g. miraculin, monellin, thaumatin, curculin, brazzein);
sweeteners (e.g. magap, sodium cyclamate, acesulfame K, neohesperidine dihydrochalcone, saccharin sodium salt, aspartame, superaspartame, neotame, alitame, sucralose, stevioside, rebaudioside, especially A and D, lugduname, carrelame, sucrononate, sucrooctate, monatin, phenylodulcin);
sweet-tasting amino acids (e.g. glycine, D-leucine, D-threonine, D-asparagine, D-phenylalanine, D-tryptophan, L-proline);
further sweet-tasting low molecular weight substances, for example hernandulcin, dihydrochalcone glycosides, glycyrrhizin, glycerrhetic acid, derivatives and salts thereof, liquorice extracts (Glycyrrhizza glabra ssp.), Lippia dulcis extracts, Momordica ssp. extracts or
single substances, for example Momordica grosvenori [Luo Han Guo] and the mogrosides obtained therefrom, Hydrangea dulcis or Stevia ssp. (e.g. Stevia rebaudiana), and Rubus extracts.

### Antioxidants and Vitamins

In a further embodiment of the present invention, the products may comprise, as a further optional group of additives, antioxidants and/or vitamins (component c12).

In the food industry, both natural and synthetic antioxidants are used. Natural and synthetic antioxidants differ primarily in that the former are naturally occurring in food and the latter are produced synthetically. For instance, natural antioxidants, if they are to be used as food additive, are obtained from vegetable oils, for example. Vitamin E—also referred to as tocopherol—is frequently produced from soya oil, for example. Synthetic antioxidants, such as propyl gallate, octyl gallate and dodecyl gallate, by contrast, are obtained by chemical synthesis. The gallates can trigger allergies in sensitive persons. Further usable antioxidants in compositions of the present invention are: sulfur dioxide, E 220 sodium sulfite, E 221 sodium hydrogensulfite, E 222 sodium disulfite, E 223 potassium disulfite, E 224 calcium sulfite, E 226 calcium hydrogensulfite, E 227 potassium hydrogensulfite, E 228 lactic acid, E 270 ascorbic acid, E 300 sodium L-ascorbate, E 301 calcium L-ascorbate, E 302 ascorbic esters, E 304 tocopherol, E 306 alpha-tocopherol, E 307 gamma-tocopherol, E 308 delta-tocopherol, E 309 propyl gallate, E 310 octyl gallate, E 311 dodecyl gallate, E 312 isoascorbic acid, E 315 sodium isoascorbate, E 316 tert-butylhydroquinone (TBHQ), E 319 butylhydroxianisole, E 320 butylhydroxytoluene, E 321 lecithin, E 322 citric acid, E 330 salts of citric acid (E 331 & E 332) sodium citrate, E 331 potassium citrate, E 332 calcium-disodium-EDTA, E 385 diphosphates, E 450 disodium diphosphate, E 450a trisodium diphosphate, E 450b tetrasodium diphosphate, E 450c dipotassium diphosphate, E 450d tripotassium diphosphate, E 450e dicalcium diphosphate, E 450f calcium dihydrogendiphosphate, E 450g triphosphates, E 451 pentasodium triphosphate, E 451a pentapotassium triphosphate, E 451b polyphosphate, E 452 sodium polyphosphate, E 452a potassium polyphosphate, E 452b sodium calcium polyphosphate, E 452c calcium polyphosphate, E 452d tin(II) chloride, E 512.

Vitamins have a wide variety of different mechanisms of biochemical action. Some act like hormones and regulate mineral metabolism (e.g. vitamin D), or act on the growth of cells and tissue and cell differentiation (e.g. some forms of vitamin a). Others are antioxidants (e.g. vitamin E and, under some circumstances, vitamin C as well). The majority of vitamins (e.g. the B vitamins) are precursors of enzymatic cofactors that assist enzymes in catalysing particular processes in metabolism. In this connection, vitamins may sometimes be tightly bound to the enzymes, for example as part of the prosthetic group: one example of this is biotin, which is part of the enzyme responsible for the formation of fatty acids. Vitamins may alternatively also be less strongly bound and in that case act as co-catalysts, for example as groups that can be eliminated readily and transport chemical groups or electrons between the molecules. For example, folic acid transports methyl, formyl and methylene groups into the cell. Even though their assistance in enzyme-substrate reactions is well known, the other properties thereof are also of great significance for the body.

In the context of present invention, useful vitamins are substances selected from the group consisting of
vitamin A (retinol, retinal, betacarotene),
vitamin B1 (thiamine),
vitamin B2 (riboflavin),
vitamin B3 (niacin, niacinamide),
vitamin B5 (pantothenic acid),
vitamin B6 (pyridoxine, pyridoxamine, paridoxal),
vitamin B7 (biotin),
vitamin B9 (folic acid),
vitamin B12 (cyanocobalamin, hydroxycobalamin, methylcobalamin),
vitamin C (ascorbic acid),
vitamin D (cholecalciferol),
vitamin E (tocopherols, tocotrienols) and
vitamin K (phylloquinone, menaquinone).
   The preferred vitamins, aside from ascorbic acid, are the group of the tocopherols.

### Salts

Useful salts (component c14) include sodium chloride, magnesium chloride and potassium chloride.

### Food Dyes

Food dyes or dyes for short (component c15) are food additives for colouring foods. Dyes are divided into the groups of natural dyes and synthetic dyes. The nature-identical dyes are likewise of synthetic origin. The nature-identical dyes are synthetic analogues of naturally occurring colouring substances. Suitable dyes for use in the present composition are selected from: curcumin, E 100 riboflavin, lactoflavin, vitamin B2, E 101 tartrazine, E 102 quinoline yellow, E 104 yellow orange S, yellow orange RGL, E 110 cochineal, carminic acid, true carmine, E 120 azorubine, carmoisin, E 122 amaranth, E 123 cochineal red A, Ponceau 4 R, Victoria scarlet 4 R, E 124 erythrosine, E 127 allura red AC, E 129 patent blue V, E 131 indigo tin, indigo carmine, E 132 brilliant blue FCF, patent blue AE, amido blue AE, E 133 chlorophylls, chlorophyllins, E 140 copper complexes of the chlorophylls, copper-chlorophyllin complex, E 141 brilliant acid green, green S, E 142 caramel colour, E 150 a caustic sulfite caramel, E 150 b ammonia caramel, E 150 c ammonium sulfite caramel, E 150 d brilliant black FCF, brilliant black PN, black PN, E 151 plant charcoal, E 153 brown FK, E 154 brown HT, E 155 carotene, E 160 a annatto, bixin, norbixin, E 160 b capsanthin, capsorubin, E 160 c lycopene, E 160 d beta-apo-8′-carotinal, apocarotinal, beta-apocarotinal, E 160 e beta-apo-8′-carotenoic acid ethyl ester (C30), apocarotenoic ester, beta-carotenoic ester, E 160 f lutein, xanthophyll, E 161 b canthaxanthin, E 161 g betanin, beetroot red, E 162 anthocyanins, E 163 calcium carbonate, E 170 titanium dioxide, E 171 iron oxides, iron hydroxides, E 172 aluminium, E 173 silver, E 174 gold, E 175 litholrubin BK, rubin pigment BK, E 180.

The desserts according to the invention may also contain chocolate, cocoa, nuts or fruits in the form of pieces or in finely divided form.

The desserts according to the invention are preferably quark desserts, yoghurt products, kefir products or milk-based puddings (including those in the form of mousse). It is also a feature of the desserts that they have a sugar content of less than 2% by weight and/or are essentially free of cream (less than 2% by weight).

### INDUSTRIAL APPLICABILITY

The present invention further provides for the use of galactooligosaccharides prepared as described above as cream substitute.

### EXAMPLES

### Comparative Example V1

### Deactivation of the Mass of Enzyme by pH Shift

1000 kg of a skimmed milk with 30-50% by weight of dry matter was heated to 98° C. in a tubular heat exchanger for 120 seconds, and hence sterilized. The sterilized solution was cooled down to 50° C., transferred into a fermenter, admixed with beta-galactosidase from Bacillus circulans in an enzyme:substrate weight ratio of 1:500, and stirred. The progress of the transgalactosylation was monitored by sampling. After about 15 minutes of enzymation time, the later viscosity maximum was attained. The pH was adjusted to 10.0 by addition of 30% by weight sodium hydroxide solution within a few minutes, which abruptly reduced the activity of the enzyme by 80%. No rise in viscosity was observed; the resulting product was liquid and of low viscosity.

### Example 1

### Thermal Deactivation of the Mass of Enzyme

1000 kg of a skimmed milk with 30-50% by weight of dry matter was heated to 98° C. in a tubular heat exchanger for 120 seconds, and hence sterilized. The sterilized solution was cooled down to 50° C., transferred into a fermenter, admixed with beta-galactosidase from Bacillus circulans in an enzyme:substrate weight ratio of 1:500, and stirred. The progress of the transgalactosylation was monitored by sampling. After about 15 minutes of enzymation time, the later viscosity maximum was attained. The reaction mixture was then heated to 98° C. within 30 seconds, and left at that temperature for a further 10 minutes. The resulting product showed the consistency of a gel.

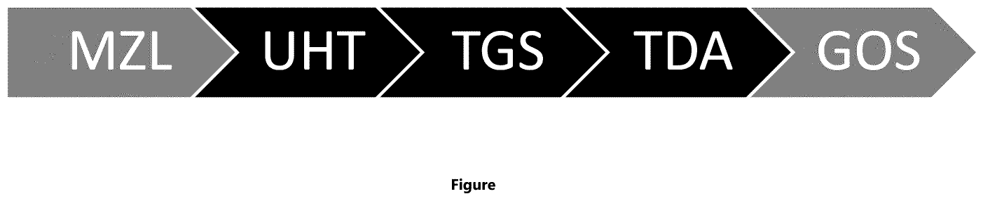

The process for producing the specific GOS is also elucidated in detail by a flow diagram according to FIG. 1; the abbreviations mean:

MZL: lactose solution
UHT: ultra heat treatment
TGS: transgalactosylation
TDA: thermal deactivation
GOS: galactooligosaccharides

### Formulation Examples

A cream quark and a creamy pudding according to the components in Table 1 were produced by mixing at 20° C. and then homogenized at 100 rpm for 30 seconds. Subsequently, creaminess and taste were assessed by 5 testers, who all arrived at the same result.

TABLE 1
Formulation examples (amounts in g)

| | Cream quark | | Creamy pudding | |
|---|---|---|---|---|
| Components | V1 | 1 | V2 | 2 |
| Whole milk | 5 | 5 | 300 | 300 |
| Quark | 200 | 200 | | |
| Cream | 100 | — | 200 | |
| GOS Ex. 1 | — | 100 | | 200 |
| Starch | — | — | 40 | 40 |
| Sugar | 2 | 2 | 2 | 2 |

Creaminess by comparison

| | |
|---|---|
| identical | identical |

Taste assessment by comparison

| | |
|---|---|
| identical, GOS product | identical, GOS product |
| is perceived as being | is perceived as being |
| sweeter and fullbodied | sweeter and fullbodied |

Accordingly, the amount of cream in the products was exchangeable for the same weight of the specific GOS without any change in creaminess of the products. Nor did the GOS result in any impairment of taste. However, the products tended to be assessed as being sweeter, which offers the possibility of reducing the amount of GOS compared to the amount of cream in order to achieve the same sweetness as well.

1. A low-calorie dessert comprising
(a) at least one milk component; and
(b) galactooligosaccharides (GOS),
wherein component (b) is obtained by the following steps:
(i) providing an aqueous solution comprising proteins and lactose;
(ii) concentrating the aqueous solution from step;
(iii) sterilizing the aqueous solution from step (ii) by pasteurization or microfiltration;
(iv) transgalactosylating the lactose present in the sterilized aqueous solution from step (iii) with addition of at least one beta-galactosidase within the optimal temperature and pH interval thereof over a period of at least 30 minutes to obtain a reaction mixture;
(v) deactivating the mass of enzyme in the reaction mixture from step (iv) by thermal treatment over a period of about 5 to about 20 minutes; and optionally
(vi) finishing the product thus obtained.

2. A low-calorie dessert according to claim 1, wherein component (a) is selected from the group formed by skimmed milk, whole milk, yoghurt, buttermilk, sweet whey, acid whey, cream, kefir and quark.

3. A low-calorie dessert according to claim 1, further comprising auxiliaries and additives selected from the group consisting of plant proteins, plant fats, starch products, dietary fibres, thickeners, flavourings, prebiotics, probiotics, food acids, rennet, salts and dyes, and mixtures thereof.

4. A low-calorie dessert according to claim 1, having the following composition, based in each case on the total weight:
(a) about 50% to about 80% by weight of milk components;
(b) about 5% to about 60% by weight of galactooligosaccharides;
(c1) 0% to about 10% by weight of plant proteins;
(c2) 0% to about 10% by weight of plant fats;
(c3) 0% to about 5% by weight of starch products;
(c4) 0% to about 5% by weight of dietary fibres;
(c5) 0% to about 5% by weight of emulsifiers;
(c6) 0% to about 2% by weight of thickeners;
(c7) 0% to about 2% by weight of flavourings;
(c8) 0% to about 1% by weight of probiotic microorganisms;
(c9) 0% to about 1% by weight of prebiotic substances;
(c10) 0% to about 1% by weight of food acids;
(c11) 0% to about 1% by weight of sweeteners;
(c12) 0% to about 1% by weight of antioxidants and/or vitamins;
(c13) 0% to about 1% by weight of rennet;
(c14) 0% to about 1% by weight of salts;
(c15) 0% to about 0.5% by weight of dyes;
wherein the stated amounts, with or without water, add up to 100% by weight.

5. A low-calorie dessert according to claim 1, further comprising chocolate, cocoa, nuts or fruits in the form of pieces or in finely divided form.

6. A low-calorie dessert according to claim 1, which is quark desserts, yoghurt products, kefir products or milk-based puddings.

7. A low-calorie dessert according to claim 1, having a sugar content of less than 2% by weight.

8. A low-calorie dessert according to claim 1, essentially free of cream.

9. A low-calorie dessert according to claim 1, comprising the additional step of
(vii) using the galactooligosaccharides as cream substitute.
